(19) United States
(12) Patent Application Publication
(10) Pub. No.: US 2005/0060552 A1
(43) Pub. Date: Mar. 17, 2005

(54) Program, recording medium and reproduction apparatus

(76) Inventors: Naozumi Sugimura, Yokohama (JP); Takuya Imaide, Fujisawa (JP); Susumu Yoshida, Kawasaki (JP); Toshihiro Kato, Tokyo (JP); Akinobu Watanabe, Fujisawa (JP); Nozomu Shimoda, Ninomiya (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/928,561

(22) Filed: Aug. 30, 2004

(30) Foreign Application Priority Data
Sep. 17, 2003 (JP) 2003-323902

(51) Int. Cl. H04K 1/00

(52) U.S. Cl. 713/182

(57) ABSTRACT

In an apparatus not connected to a network can perform the reproduction within a valid viewing period. Also, in order to facilitate the change of the encryption algorithms of a password, a program recorded on the disk comprises the steps of acquiring a first medium identification number recorded on a recording medium, acquiring the current time, acquiring a password, calculating a second medium identification number and the expiry date of the valid viewing period from the password, comparing the first medium identification number with the second medium identification number, and comparing the current time with the expiry date of the valid viewing period. In the case where the first medium identification number coincides with the second medium identification number and the current time has not passed the expiry date of the valid viewing period, then the predetermined information is reproduced from the recording medium.

### BACKGROUND OF THE INVENTION

The present invention relates to a reproduction apparatus for reproducing the image information recorded in a recording medium, or in particular to a reproduction apparatus for reproducing the image information recorded in an optical disk, a program used for reproduction and a recording medium for recording the program.

To rent a video tape or a DVD, the user is required to take the trouble of going to a video rental house. To eliminate this inconvenience, a method has been conceived in which a disk is distributed free of charge or at a normal price to the user who can view the disk at a charge only whenever he/she desires (e.g. JP-A-2001-306684).

### SUMMARY OF THE INVENTION

The conventional method of securing a viewing period through a network, however, has the disadvantage that any device not connected to the network cannot be used. Especially, a portable player and an on-vehicle player pose a great problem.

In view of this problem, an object of this invention is to provide an apparatus in which even a device not connected to the network can reproduce audio-visual (AV) data within a valid viewing period.

Another object of the invention is to provide an apparatus in which data is protected with higher security by executing the process of encrypting and decrypting the data according to a program recorded in the disk.

According to this invention, there is provided program product for controlling the reproduction of information from a recording medium, comprising the steps of:
acquiring a first medium identification number recorded on a recording medium;
acquiring the current time;
acquiring a password;
calculating a second identification number and the expiry date of the valid viewing period from the password;
comparing the first medium identification number with the second medium identification number; and
comparing the current time with the expiry date of the valid viewing period;
wherein predetermined information is reproduced from the recording medium only in the case the first medium identification number coincides with the second medium identification number and the current time has not passed the expiry date of the valid viewing period. This program product may be a recording medium or a reproduction apparatus.

According to the invention, even a device not connected to the network can reproduce the AV data within the valid viewing period by inputting a password.

Also, the password is encrypted and decrypted according to the program recorded on the disk, and therefore a different disk can have a different encryption algorithm. Specifically, should an encryption algorithm be successfully analyzed, other disks cannot be reproduced with the particular encryption algorithm and therefore the data can be protected with higher security.

Other objects, features and advantages of the invention will become apparent from the following description of the embodiments of the invention taken in conjunction with the accompanying drawings.

### BRIEF DESCRIPTION OF THE DRAWINGS

FIG. 1 is a flowchart showing the operation according to a reproduction control program.

FIG. 2 shows the relation between the disk number, the valid viewing period and the password.

FIG. 3 shows an example of a password input screen.

FIG. 4 shows an example of the valid viewing period display screen.

FIG. 5 shows an example of an input screen of a server providing a password.

FIG. 6 shows an example of a screen for providing a password.

FIG. 7 is a block diagram showing a reproduction apparatus.

FIG. 8 shows an outline of the disk having a BCA (burst cutting area) recorded therein.

FIG. 9 is a flowchart showing the operation according to a reproduction control program.

FIG. 10 is a block diagram showing a reproduction apparatus.

FIG. 11 is a diagram showing the connection of a server and a reproduction apparatus.

FIG. 12 shows the steps of communication between a server and a reproduction apparatus.

FIG. 13 shows the relation between the disk number, the title number, the valid viewing period and the password.

FIG. 14 shows an example of a viewing screen for a plurality of titles.

### DESCRIPTION OF THE EMBODIMENTS

Embodiments of the invention are described below.

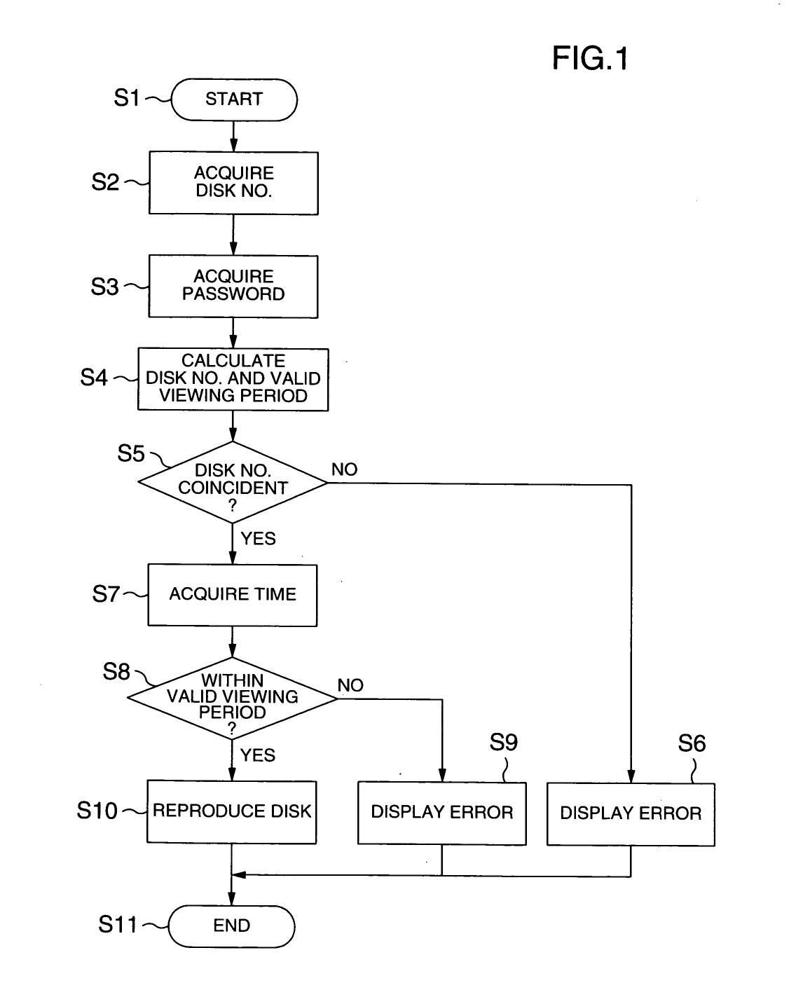

FIG. 1 is a flowchart showing a specific operation for a reproduction control program according to the invention.

In FIG. 1, reference numeral S1 designates a step for starting the process, numeral S2 a step for acquiring a disk number, numeral S3 a step for acquiring a password, numeral S4 a step for calculating the disk number and the valid viewing period, numeral S5 a step for judging the coincidence of the disk number, numeral S6 an error display step for notifying the incoincidence of the disk number, numeral S7 a step for acquiring the current time, numeral S8 a step for comparing the valid viewing period with the current time, numeral S9 an error display step for notifying the expiry of the valid viewing period, numeral S10 a step for reproducing the disk, and numeral S11 a step for ending the process.

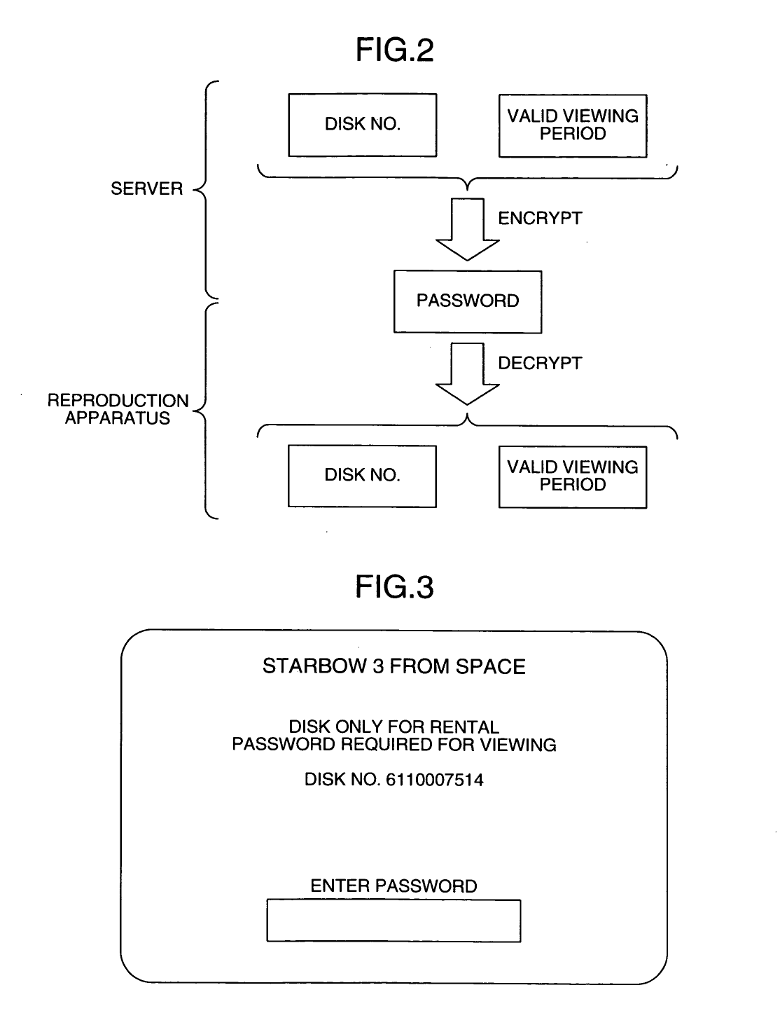

FIG. 2 is a diagram showing the relation between the disk number, the valid viewing period and the password.

As shown in FIG. 2, the disk number and the valid viewing period are encrypted in a predetermined way on a server and supplied as a password.

According to the program executed in the reproduction apparatus, a predetermined decryption process is executed based on the supplied password so that the disk number and the valid viewing period are calculated.

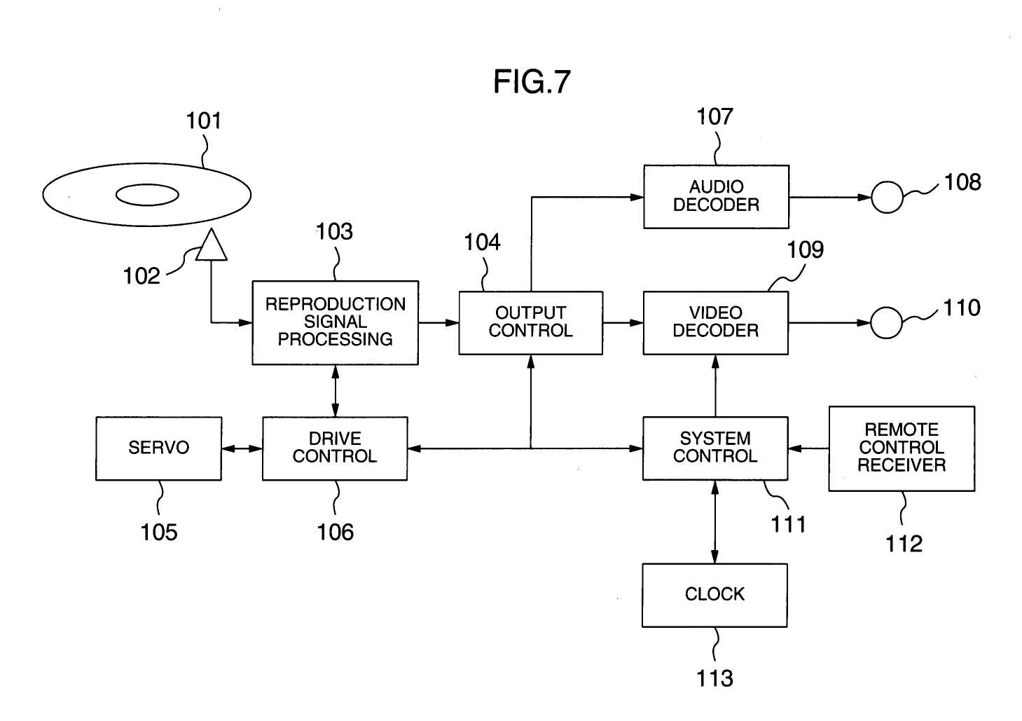

The program is defined as a record of the procedure for executing a predetermined process through predetermined steps, and generally includes the C language, JAVA (registered trademark), BASIC language or the machine language. These programs are analyzed sequentially in a program execution environment and the process is executed through the steps determined by a particular program. In the reproduction apparatus according to the invention, the control unit shown in FIG. 7 includes a program execution environment, in which the control unit sequentially analyzes and executes the programs, as described in detail later.

The program flowchart shown in FIG. 1 is explained step by step.

First, with the starting of the execution of a program (S1), the disk number is acquired (S2). Though specifically described later, the disk number is acquired simply by accessing a predetermined disk number acquisition subroutine on the program. The subroutine as called herein is anonymous with the function, API (application program interface) or BIOS (basic input/output system).

The disk number is returned from the subroutine as an integer of ten digits, for example. A different disk number may be set for a different disk or a different disk title.

Next, a password is acquired (S3). Specifically, first, a screen prompting to input a password is displayed as shown in FIG. 3. In the process, the disk number is desirably displayed to help the user discriminate a particular disk being reproduced. The user inputs a password corresponding to the disk number. The password can be input by using numerical buttons of a remote controller, for example. Nevertheless, the disk number and the password can alternatively be exchanged through the network, or the password memorized beforehand in an IC card may be input. The method by which the user acquires the password is described later.

The password, once input, is decoded to calculate the disk number and the valid viewing period (S4). In the process, the password may be encrypted using the RSA cryptography not to be readily decoded. The password, as shown in FIG. 2, is the encryption of the disk number and the valid viewing period combined, and can be decrypted by following the order reverse to encryption. In this way, the disk number and the viewing period are determined from the password.

Next, the disk number calculated is compared with the actual disk number of the disk to be reproduced (S5). A different password is formed for a different disk number, and therefore in the case where the disk number calculated from the password is different from the actual disk number of the disk to be reproduced, the disk is not reproduced and an error message indicating the password incoincidence is displayed (S6).

In the case where the disk number is coincident, the current time is acquired (S7) and compared with the valid viewing period (S8). The current time can be easily acquired by use of the clock built in the reproduction apparatus. In the case where the subroutine for acquiring the current time is prepared, the program can be easily formed. The information such as the current time and the valid viewing period can be determined on daily basis, such as Sep. 20, 2003. Nevertheless, the current time and the valid viewing period may alternatively be determined in detailed way on the order of the hour. Also, in the case where the valid viewing period is set as infinite, the same effect is produced as the purchase instead of rental. This can be implemented by setting such an imaginary or unrealistic expiry date of the valid viewing period as December 31, 9999.

In the case where the current time has passed the viewing period, the expiry of the valid viewing period is notified to the user (S9). Then, the user is required to acquire a password anew.

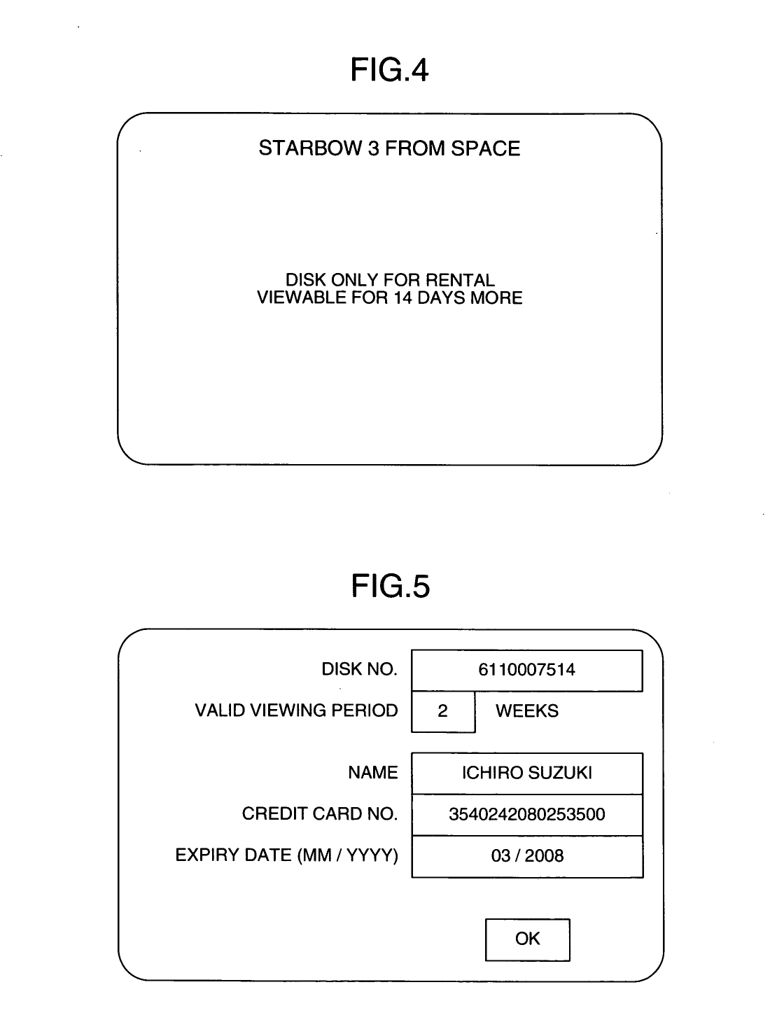

In the case where comparison between the current time and the valid viewing period shows that the viewing period has not yet expired, the reproduction of information recorded in the disk is started (S10). Specifically, the AV information such as a movie or music recorded in the disk is reproduced. At the same time, the remaining number of days before the expiry date of the valid viewing period is desirably notified to the user as shown in FIG. 4. The expiry time of the valid viewing period may of course be expressed as the expiry date and time.

Next, a method of acquiring the password by the user is explained.

The password, as shown in FIG. 2, is a combination of the disk number and the valid viewing period. The server providing the password, therefore, generates the password from the information of the disk number and the valid viewing period and supplies it to the user.

The user accesses the server providing the password through a network from a terminal connected to the network. Specifically, the user accesses the homepage of a service provider using a personal computer connected to the internet, or accesses the server of the service provider using a mobile telephone adapted for the network.

An example of the homepage of the service provider providing the password is shown in FIG. 5. In FIG. 5, the user is prompted to input the disk number, the valid viewing period, his/her name, the credit card number with the expiry date thereof. The disk number and the viewing period are used to generate a password. The name and the credit card number with the expiry date thereof, on the other hand, are used for charging. The valid viewing period can be arbitrarily selected by the user. As an alternative, the valid viewing period may of course be fixed to “one week”, etc. or designated by the date until which it holds good. The amount of fee charged may be calculated in accordance with the disk number and the actual period of use.

Once the information are input by the user, the server first makes an inquiry of the credit card company about whether the credit card is valid or not and, if valid, charges a predetermined amount of fee. At the same time, the user is desirably notified of the actual outstanding amount of fee.

Next, the server issuing the password calculates the date and time of expiry of the valid viewing period based on the current time and the valid viewing period, and generates a password by encrypting the information on the valid viewing period and the disk number in a predetermined way. The cryptography used for this purpose corresponds to the reproduction control program described above.

The reproduction control program recorded in a disk can be determined from the disk number thereof. Therefore, a different encryption method or a different parameter can be used for a different reproduction control program. Since a different encryption method can be used for each disk in this way, a successful analysis of the encryption algorithm of the password of a specific disk would fail to lead to successful decoding of disks of different encryption algorithms. The adverse effect, therefore, can be minimized.

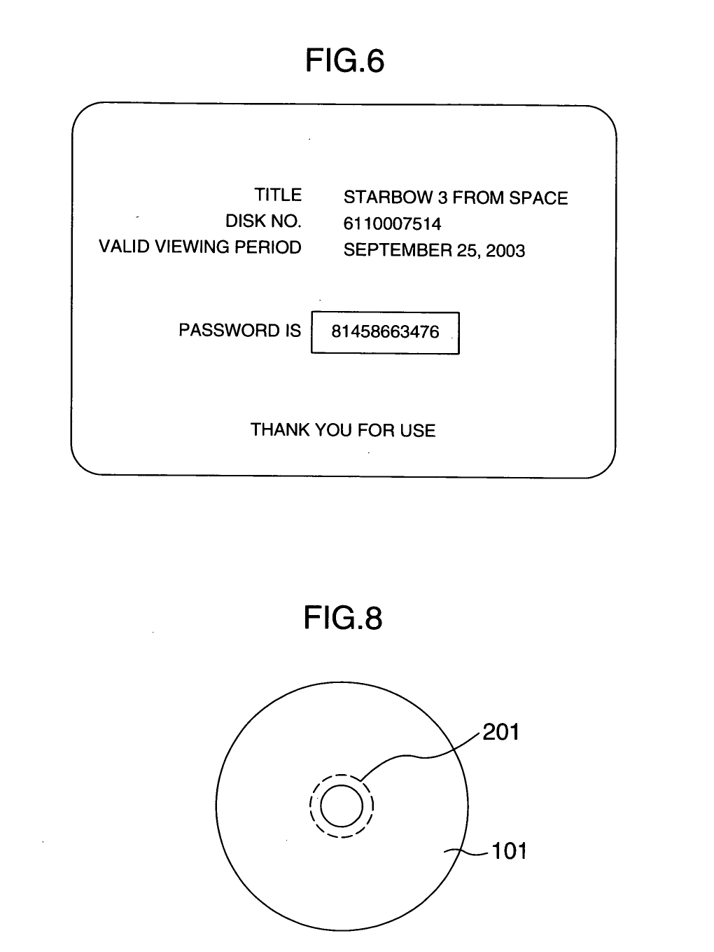

The password generated is notified to the user as shown in FIG. 6. The user can reproduce the disk by inputting the particular password in the reproduction apparatus.

In the embodiment described above, the server providing the password is accessed through a network from a terminal connected to the network. The access, however, is not necessarily limited to this method. For example, a given user may have no terminal connected to the network. In such a case, a method may be employed in which the user phones and notifies the call center of the service provider of the disk number and other information to acquire a password. As another alternative, such information device as facsimile or electronic mail may be used. The information may of course be exchanged with the service provider using ordinary letters. The feature of the method of providing a password according to this invention lies in that a password encrypted in a way corresponding to the disk number is supplied to the user.

Now, a reproduction apparatus according to an embodiment of the invention is explained.

FIG. 7 is a block diagram showing a reproduction apparatus according to this invention.

In FIG. 7, reference numeral 101 designates an optical disk, numeral 102 an optical pickup for reading the signals from the optical disk 101, numeral 103 a reproduction signal processing circuit for reproducing the data by predetermined demodulation of the signal reproduced from the optical disk 101, numeral 104 an output control unit for outputting the reproduced data at a predetermined timing, numeral 105 a servo unit for controlling the rotational speed of the optical disk 101 and the position of the optical pickup 102, numeral 106 a drive control unit for controlling the servo unit 105 and the reproduction signal processing circuit 103, numeral 107 an audio decoder for decoding the audio signal, numeral 108 an audio output terminal for outputting the decoded audio signal, numeral 109 a video decoder for decoding the video signal, numeral 110 a video output terminal for outputting the decoded video signal, numeral 111 a system control unit for controlling the whole reproduction apparatus, numeral 112 a remote control receiving unit for receiving the signal from a remote controller, and numeral 113 a clock.

First, the user sets the desired optical disk 101 in the reproduction apparatus, and depresses the replay button of the remote controller (not shown). The signal from the remote controller is received by the remote control receiving unit 112 and input to the system control unit 111. The system control unit 111 starts the reproduction of the optical disk 101 in compliance with a reproduction start instruction from the remote controller.

In addition to the AV information file with images and voices recorded therein, a play list file indicating the order of reproduction of the AV information file and a program file for executing the steps in a predetermined order are recorded on the optical disk 101.

First, the optical disk 101 is set, and the file management information area read. Specifically, the system control unit 111 instructs the drive control unit 106 to read the data of a predetermined sector with the file management information recorded therein. The drive control unit 106, in compliance with the instruction from the system control unit 111, controls the servo unit 105 to read the data from the designated sector. To make it possible to read the data, the servo unit 105 controls the rotational speed of the optical disk 101 on the one hand and controls the position of the optical pickup 102 on the other. The data recorded on the optical disk is read from the optical pickup 102, and input to the reproduction signal processing circuit 103 as an electrical signal. The reproduction signal processing circuit 103, based on the input electrical signal, detects the number of the sector read and inputs it to the drive control unit 106. The drive control unit 106 calculates the error between the read sector number sent from the reproduction signal processing circuit and the target sector number and thereby controls the servo unit.

Once the data of the target sector is read, the reproduction signal processing circuit 103 executes the process of demodulating the data thus read, correcting the error and sorting the data, and accumulates them as the sector data on the memory. The drive control unit 106 reads the prepared sector data and supplies it to the system control unit 111.

The file management information has recorded therein such information as the file identifier (file name) of each file, the sector number with which to start the file record and the data length. By use of this file management information, the process of reading the file by means of the file identifier can be carried out.

Using the data of the file management information that has been read as above, the system control unit executes the process of reading the file.

At the time of starting the reproduction, the bootstrap program is first read and processed. The bootstrap program is recorded on the disk in a predetermined file name. The bootstrap program is the reproduction control program shown in FIG. 1, and the operation thereof is described below.

The system control unit 111 acquires the information corresponding to the file name used for bootstrapping, from the file management information. Specifically, the information include the sector position with which the recording starts and the data length of the file used for bootstrapping.

The system control unit 111 gives an instruction to the drive control unit 106 to read the data from the recording start sector position thus determined. The drive control unit controls the servo unit 105 thereby to control the rotational speed of the optical disk 101 and the position of the optical pickup 102, thus reading the data from the designated sector. The sector data thus read are sent to the system control unit through the drive control unit 106.

The system control unit 111 analyzes the bootstrap file that has been read. The bootstrap file has added thereto the information as to whether the particular file is a play list or a program, and the process is executed in accordance with this information. The bootstrap file is the reproduction control program shown in FIG. 1, and therefore has added thereto the information indicating that the file is a program. The system control unit 111 executes the process using the read file as a program. Specifically, the program read is developed in the storage area (RAM) in the system control unit 111 and sequentially analyzed. The program recorded on the disk may be encrypted in a way not to be easily analyzed by the user.

The reproduction control program shown in FIG. 1 uses a subroutine to obtain the disk number of the optical disk. This is a special operation not prepared as an ordinary environment for program execution. Once this subroutine is accessed, the system control unit 111 sends an instruction to the drive control unit 106 to read the disk identification number called BCA (burst cutting area). The drive control unit 106 reads the BCA information recorded on the optical disk 101, and returns it to the system control unit 106. The system control unit 111 executes the program using the BCA information that has been read.

A method of recording BCA used as the disk number is explained below.

FIG. 8 shows an outline of the optical disk, and numeral 201 designates a BCA recording area.

Normally, the read-only optical disk records the data in terms of presence or absence of an uneven part called the pit on the disk. By using an uneven original disk for press work, a great number of optical disks having the same information recorded therein are fabricated.

In the BCA 201, in contrast, the inner side of the normal data area of the optical disk 101 is scratched using a special laser beam thereby to record the identification unique to each disk. As a result, a different identification can be recorded in each disk. The BCA information can be read utilizing the difference in light reflectivity by means of the conventional optical pickup 102.

The BCA has recorded therein the name of the maker of the contents recorded in the disk, the title, the series name and the serial number in digits, which are used as a disk number.

This embodiment represents a case in which the information written in the BCA area is used for detection of the disk number. The invention, however, is not limited to this method, and the information of any type capable of identifying the disk can be used. The use of the information written in a predetermined sector on the disk is an example. A part of the information written as a file on the disk is used for identifying the disk as another example. As still another alternative, the information like bar code is written on the disk and read by a dedicated reader and input to the control unit. The use of a semiconductor chip embedded in the disk from which information is read as a disk identification is of course yet another alternative.

Next, the operation of reproducing the AV data from the disk is explained.

The password is checked by the reproduction control program shown in FIG. 1, and in the case where the disk number and the valid viewing period meet the required conditions, the AV data recorded on the disk is reproduced (S10).

Both the actual AV data and the data indicating the order of reproduction called a play list are recorded on the disk. In the AV data reproduction step (S10) of the reproduction control program, the file name of the play list for reproduction is designated, and the AV data are reproduced in the order described in the play list.

Specifically, the play list designated in the AV data reproduction step (S10) is read first of all. The system control unit 111 acquires the data length and the sector number at which the play list file designated in the file management information is recorded, and instructs the drive control unit to read the data.

The play list thus read contains such information as the file name of the AV data, the reproduction start packet number and the reproduction end packet number. In accordance with these information, the system control unit reproduces the AV data.

At the time of reproduction of the AV data, the system control unit 111 instructs the drive control unit 106 to reproduce the sector with the AV data recorded therein. Next, the reproduced AV data is input to the output control unit 104 from the reproduction signal processing circuit 103, and after adjustment of the output timing, demultiplexed into the audio data and the video data, which are input to the audio decoder 107 and the video decoder 109, respectively.

The AV data are the data compressed by MPEG2 scheme and recorded as a MPEG transport stream having the length of 188 bytes. Also, in order to control the output packet interval, each packet has added thereto a time stamp of 30 bits. The output control unit controls the output timing in accordance with this time stamp.

The audio decoder 107 decodes the input audio data and outputs it as an audio signal from the audio output terminal 108. In similar fashion, the video decoder 109 decodes the video data and outputs it as a video signal from the video output terminal 110.

As described above, the password is checked by the reproduction control program recorded on the disk, and only in the case where the disk number is coincident and the valid viewing period is prevailing, the AV data can be reproduced.

According to this embodiment, the valid viewing period is determined using only the expiration time of the valid viewing period. As an alternative, the viewing start time may be added to make reproduction possible with the arrival of a predetermined date and time.

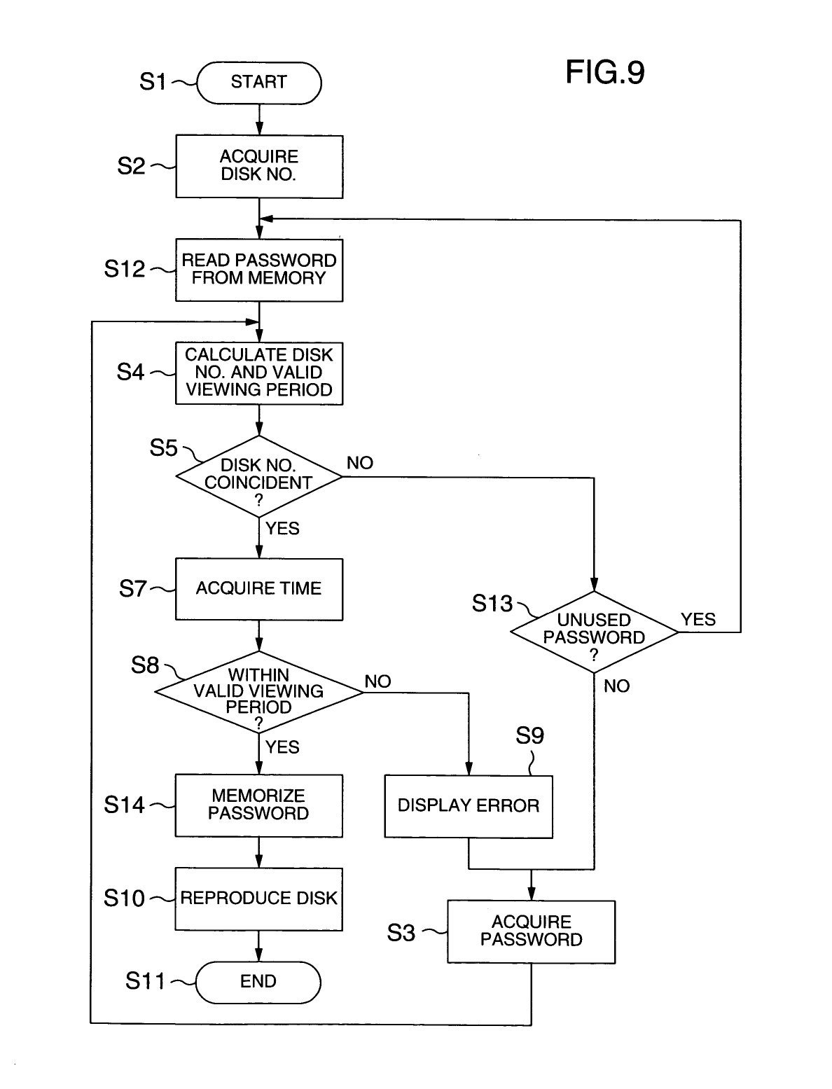

FIG. 9 is a flowchart showing the operation according to the second reproduction control program.

In FIG. 9, numeral S12 designates a step for retrieving the password from the memory, numeral S13 a step for determining whether an unused password is contained in the memory or not, and numeral S14 a step for memorizing a password.

In the reproduction control program shown in FIG. 9, the password input is memorized in the memory, while in the case where the password is already input, the need of inputting the password is eliminated.

Once the reproduction is started (S1), the disk number of the disk to be reproduced is acquired. Then, one password stored in the memory is read (S12). From the password thus read, the corresponding disk number and valid viewing period are calculated (S4) thereby to check whether the disk number is coincident or not (S5). In the case where the disk number is not coincident, another password is acquired. Specifically, the memory is checked whether it contains another password not used (S13), and in the presence of such a password, the disk number and the valid viewing period are calculated again using the particular password (S12 and S4). In the case where the password memorized in the memory fails to coincide with the disk number of the disk to be reproduced, it is determined that the password for the disk is not input and the input of the particular password is requested (S3).

In the case where the disk number of the disk to be reproduced coincides with the disk number calculated from the password memorized in the memory, the current time is acquired (S7) thereby to determine whether the valid viewing period is prevailing or not (S8). In the case where the valid viewing period has expired, the fact is displayed as an error (S9) and the password input is requested (S3).

In the case where the disk number coincides and the valid viewing period is prevailing, the input password is memorized in the memory (S14), and the AV data of the disk begins to be reproduced (S10).

As the result of the process described above, the password input is memorized in the memory. In reproducing the disk of the same disk number, therefore, it is conveniently unnecessary to input the password again.

In the block diagram of the reproduction apparatus shown in FIG. 7, the memory is not clearly shown. By using the memory built in the system control unit 111, however, the aforementioned process can be easily realized. As an alternative, an independent memory for memorizing the password may be provided or a replaceable means such as an IC card may be used.

The aforementioned embodiment refers to the case in which the password is used by being directly memorized in the memory. The invention, however, is not limited to such a configuration. For example, the disk number and the valid viewing period may be stored on the memory after being calculated from the input password. In another alternative, a password and the corresponding disk number are stored as a set. Then, the disk number can be checked without calculating the password, and therefore the processing speed is improved.

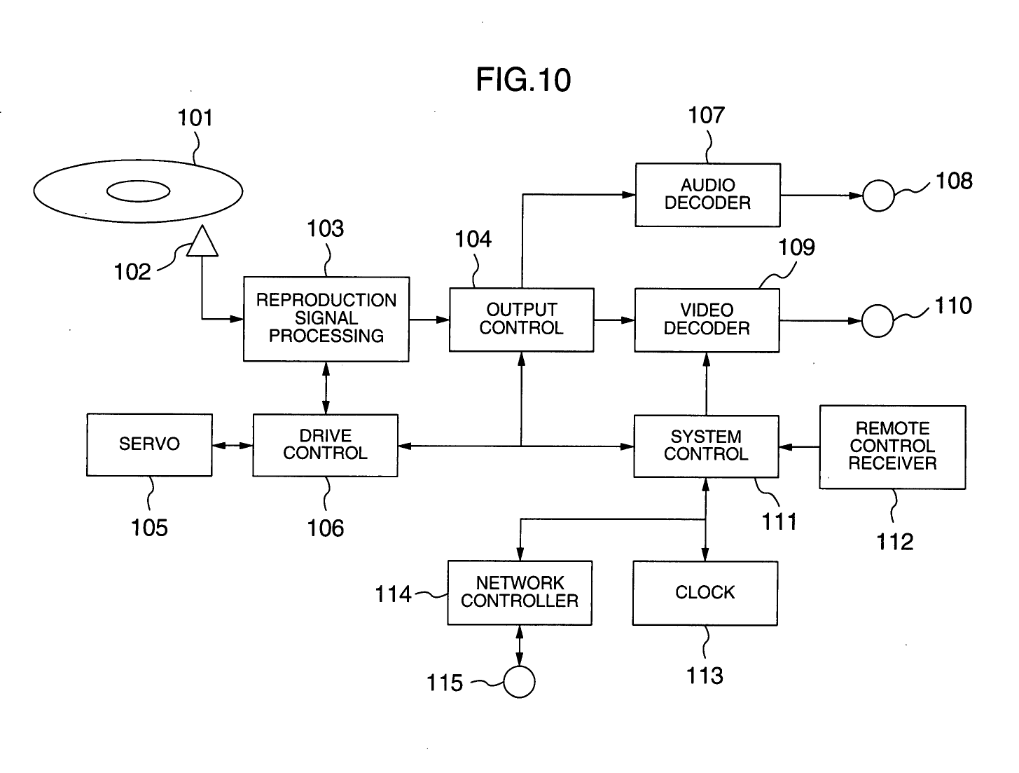

FIG. 10 is a block diagram showing a second reproduction apparatus according to the invention.

The reproduction apparatus shown in FIG. 10 is operated by being connected to a network and adapted for direct communication with the server through the network.

In FIG. 10, numeral 114 designates a network control unit, and numeral 115 a network connection terminal.

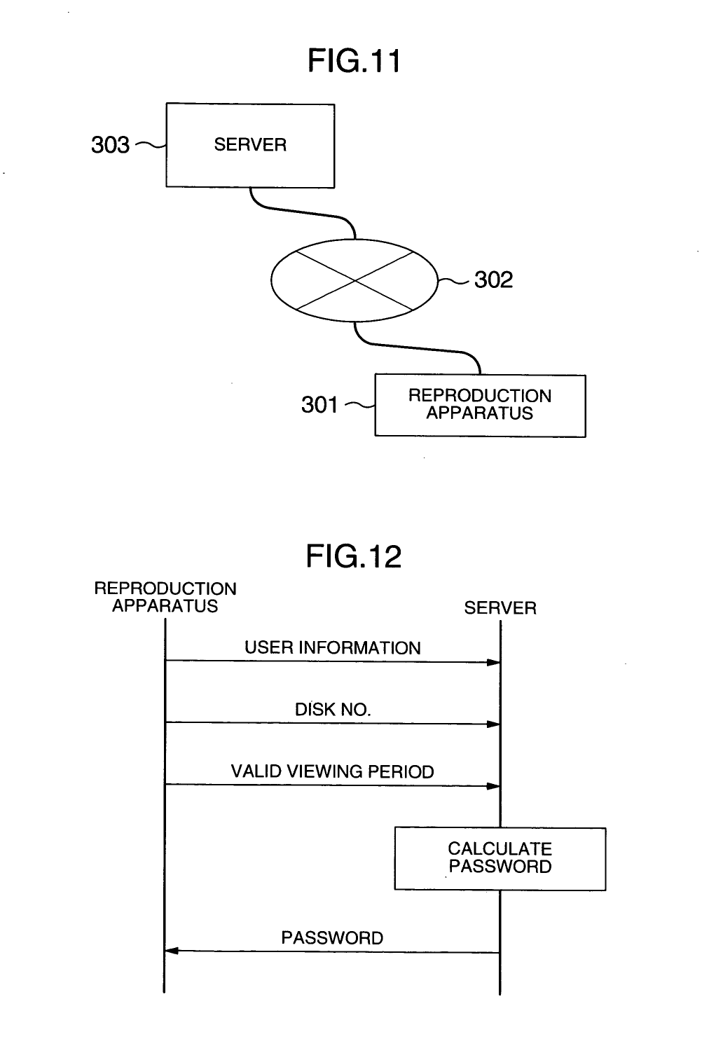

FIG. 11 shows the connection of the reproduction apparatus shown in FIG. 10 and a server.

In FIG. 11, numeral 301 designates a reproduction apparatus, numeral 302 a network and numeral 303 a server.

FIG. 12 shows the operation of communication between the reproduction apparatus shown in FIG. 10 and the server.

In the reproduction apparatus shown in FIG. 10, the system control unit is connected directly to an external server through the network control unit.

In the first reproduction apparatus shown in FIG. 7, at the time of acquisition of a password, a message is displayed to prompt the user to input the password by operating the number buttons of the remote controller.

In the reproduction apparatus 301 shown in FIG. 10 which is connected to the network, on the other hand, the password can be received directly from the server 303 through the network 302 without causing the user to input the password.

In the case where the password is required to be input, communication is established following the steps shown in FIG. 12. Specifically, the user information and the information on the disk number and the valid viewing period are transmitted from the reproduction apparatus 301 to the server 303. The server 303 generates a password from the disk number and the valid viewing period, and transmits the password thus generated to the reproduction apparatus 301. Also, the charge amount is calculated from the information on the disk number and the valid viewing period, and the user is charged based on the user information. The user information includes the credit card number.

The reproduction apparatus 301, if controlled using the password received, can reproduce the AV data in the same manner as the reproduction apparatus shown in FIG. 7.

Further, if the password received through the network as described above is memorized in the memory of the system control unit 111, the valid viewing period can be specified by use of the password in the memory even during the time when the apparatus is not connected to the network.

In the case where information are exchanged through the network, the data may be copied or eavesdropped. The data transmitted and received, therefore, are preferably encrypted in a predetermined way. The data can be encrypted also by a program. The program may be stored on the optical disk or embedded in the reproduction apparatus.

As described above, the reproduction control program and the reproduction apparatus according to the invention are applicable also with a network.

In the embodiments described above, each password is constituted of an encryption of the disk number and the valid viewing period combined as shown in FIG. 2. In this case, the possibility of reproduction for each disk is designated by one password. Nevertheless, a plurality of titles (works) can be recorded in one disk and reproduced independently of each other. For example, the user can selectively purchase only what he/she wants from among a series of movies recorded on the disk.

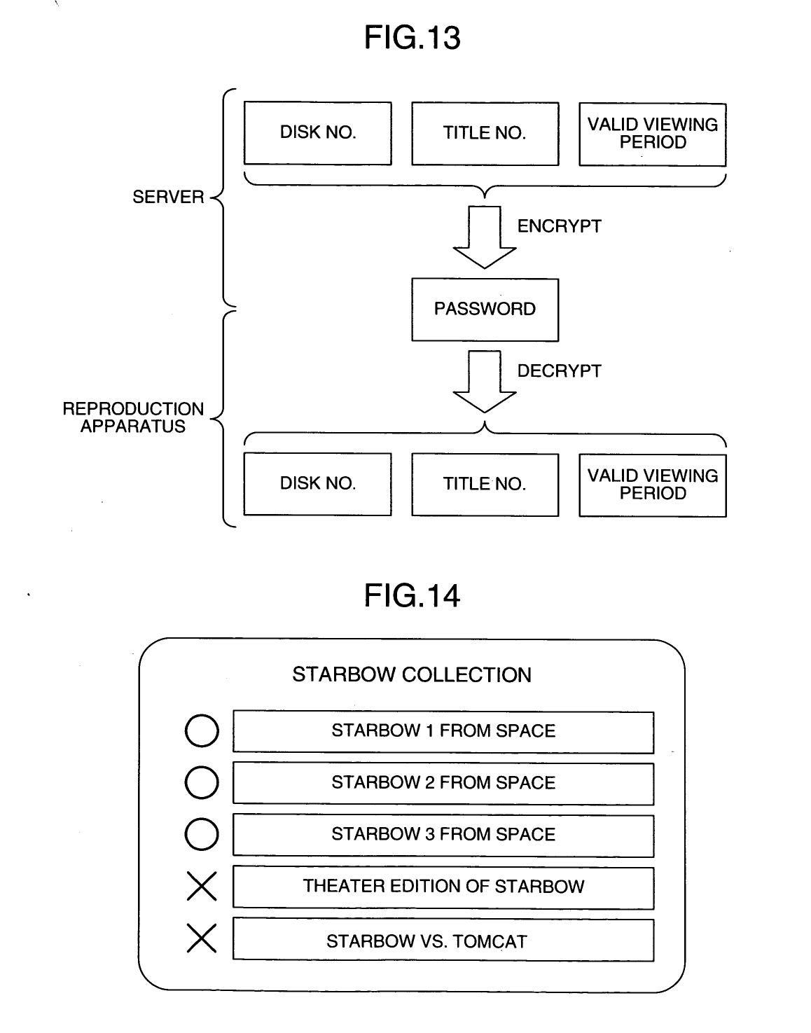

For this purpose, as shown in FIG. 13, the title number is encrypted in addition to the disk number and the valid viewing period. At the time of reproduction, the reproducibility of a given title is determined by reference to the title number as well as the disk number in the password. A plurality of titles can of course be controlled also with a single password by designating the bit position for each title number.

FIG. 14 shows an example of a plurality of titles displayed for selective reproduction. Of the five titles recorded on the disk, assume that the first to third titles can be viewed, and the user can selectively reproduce one of the three titles. In the case where other titles are required, the user takes a predetermined purchase procedure to acquire a password.

A method of managing the reproduction of a plurality of titles recorded on the disk is explained above.

Although the optical disk is taken as an example in the embodiments described above, the invention is not limited to the optical disk, but the invention is applicable with equal effect to various other recording media including a semiconductor memory and a magnetic disk.

It should be further understood by those skilled in the art that although the foregoing description has been made on embodiments of the invention, the invention is not limited thereto and various changes and modifications may be made without departing from the spirit of the invention and the scope of the appended claims.

1. A program product for controlling the reproduction of information from a recording medium, comprising the steps of:
acquiring a first medium identification number recorded in a recording medium;
acquiring a password;
calculating a second medium identification number from the password; and
comparing said first medium identification number with said second medium identification number;
wherein in the case where said first medium identification and said second medium identification number are coincident with each other, predetermined information in said recording medium is reproduced.

2. A program product according to claim 1, further comprising the steps of:
acquiring the current time;
calculating a second medium identification number and a valid viewing period from said password; and
comparing said current time with said valid viewing period;
wherein in the case where said first medium identification number coincides with said second medium identification number and said current time is included in said valid viewing period, said predetermined information in said recording medium is reproduced.

3. A program product according to claim 1,
wherein said program product is said recording medium.

4. A program product-according to claim 2,
wherein said program product is the software contained in said recording medium.

5. A program product according to claim 1,
wherein said program product is a reproduction apparatus.

6. A program product according to claim 2,
wherein said program product is the software contained in a reproduction apparatus.

7. A program product according to claim 2,
wherein the valid viewing period of the password is displayed when starting the reproduction of the information.

8. A reproduction apparatus for reproducing information from a recording medium, comprising:
means for reading a recording medium identification number recorded in said recording medium; and
means for reading and executing the program recorded in said recording medium;
wherein said program executing means includes a subroutine for notifying the recording medium identification number read by said recording medium identification number reading means.

9. A reproduction apparatus according to claim 8, further comprising:
means for reading a first recording medium identification number from said recording medium;
means for inputting a password; and
means for calculating a second recording medium identification number from said password.

10. A reproduction apparatus according to claim 9, further comprising:
a clock for counting the current time; and
means for calculating a second recording medium identification number and the valid viewing period from said password.

11. A reproduction apparatus according to claim 9, further comprising means for memorizing said password.

12. A reproduction apparatus according to claim 10, further comprising means for memorizing said password.

13. A reproduction apparatus according to claim 11, wherein said memorizing means has recorded therein said password and said recording medium identification number as a set.

14. A program product for generating a password, comprising the steps of:
inputting a recording medium identification number;
inputting the expiry date of a valid viewing period; and
generating the password from said recording medium identification number and said expiry date of said valid viewing period.

15. A server for generating and providing a password, comprising:
means for inputting a recording medium identification number and the expiry date of a valid viewing period;
wherein the program described in claim 14 is executed, and
wherein the password is generated and provided based on the recording medium identification number and the expiry date of said valid viewing period that have been input.

16. A service for generating and providing a password,
wherein the server described in claim 15 is used, and
wherein the password is generated and provided based on the recording medium identification number and the expiry date of said valid viewing period that have been input.

17. A program product according to claim 14, further comprising the steps of:
inputting a valid viewing period;
acquiring the current time;
calculating the expiry date of said valid viewing period from said current time and said valid viewing period; and
generating a password from said recording medium identification number and said expiry date of said valid viewing period.

18. A server for generating and providing a password, comprising:
means for inputting a recording medium identification number and a valid viewing period;
wherein the program according to claim 17 is executed, and
wherein the password is generated and provided based on the recording medium identification number and the viewing period that have been input.

19. A service for generating and providing a password,
wherein the server according to claim 18 is used, and
wherein the password is generated and provided based on the recording medium identification number and the valid viewing period that have been input.
